(19) United States
(12) Patent Application Publication
(10) Pub. No.: US 2020/0257979 A1
(43) Pub. Date: Aug. 13, 2020

(54) NORMALIZATION METHOD AND APPARATUS FOR DEEP NEURAL NETWORK, AND STORAGE MEDIA

(71) Applicant: SHENZHEN SENSETIME TECHNOLOGY CO., LTD., Shenzhen (CN)

(72) Inventors: Ping LUO, Shenzhen (CN); Lingyun Wu, Shenzhen (CN); Jiamin Ren, Shenzhen (CN); Zhanglin Peng, Shenzhen (CN); Ruimao Zhang, Shenzhen (CN); Xinjiang Wang, Shenzhen (CN)

(21) Appl. No.: 16/862,304

(22) Filed: Apr. 29, 2020

Related U.S. Application Data
(63) Continuation of application No. PCT/CN2019/090964, filed on Jun. 12, 2019.

(30) Foreign Application Priority Data
Jun. 13, 2018 (CN) 201810609601.0

(51) Int. Cl. G06N 3/08; G06F 16/22

(52) U.S. Cl. CPC G06N 3/08; G06F 16/2264

(57) ABSTRACT

Embodiments of the present disclosure disclose normalization methods and apparatuses for a deep neural network, devices, and storage media. The method includes: inputting an input data set into a deep neural network, the input data set including at least one piece of input data; normalizing a feature map set output by means of a network layer in the deep neural network from at least one dimension to obtain at least one dimension variance and at least one dimension mean; and determining a normalized target feature map set based on the at least one dimension variance and the at least one dimension mean. Based on the embodiments of the present disclosure, normalization is performed along at least one dimension so that statistics information of each dimension of a normalization operation is covered, thereby ensuring good robustness of statistics in each dimension without excessively depending on the batch size.

The present application is a bypass continuation of and claims priority under 35 U.S.C. § 111(a) to PCT Application. No. PCT/CN2019/090964, filed on Jun. 12, 2019, which claims priority to Chinese Patent Application No. 201810609601.0, filed with the Chinese Patent Office on Jun. 13, 2018, and entitled “NORMALIZATION METHODS AND APPARATUSES FOR DEEP NEURAL NETWORK, DEVICES, AND STORAGE MEDIA”, which is incorporated herein by reference in its entirety.

### TECHNICAL FIELD

The present disclosure relates to computer vision technologies, and in particular, to normalization methods and apparatuses for a deep neural network, devices, and storage media.

### BACKGROUND

In a neural network training process, input sample features will generally be normalized to make data become a distribution with a mean of 0 and a standard deviation of 1 or a distribution ranging from 0 to 1. If the data is not normalized, the sample features will be scattered, which may result in a slow neural network learning speed or even difficult learning.

### SUMMARY

A normalization technique in a deep neural network is provided in embodiments of the present disclosure.

According to one aspect of the embodiments of the present disclosure, provided is a normalization method for a deep neural network, including:

inputting an input data set into a deep neural network, the input data set including at least one piece of input data;

normalizing a feature map set output by means of a network layer in the deep neural network from at least one dimension to obtain at least one dimension variance and at least one dimension mean, the feature map set including at least one feature map, the feature map set corresponding to at least one channel, and each channel corresponding to at least one feature map; and

determining a normalized target feature map set based on the at least one dimension variance and the at least one dimension mean.

Optionally, the dimension includes at least one of:

a spatial dimension, a channel dimension, or a batch coordinate dimension.

Optionally, the normalizing a feature map set output by means of a neural network layer from at least one dimension to obtain at least one dimension variance and at least one dimension mean includes:

normalizing the feature map set based on the spatial dimension to obtain a spatial dimension variance and a spatial dimension mean; and/or,

normalizing the feature map set based on the channel dimension to obtain a channel dimension variance and a channel dimension mean; and/or,

normalizing the feature map set based on the batch coordinate dimension to obtain a batch coordinate dimension variance and a batch coordinate dimension mean.

Optionally, the normalizing the feature map set based on the channel dimension to obtain a channel dimension variance and a channel dimension mean includes:

obtaining the channel dimension mean based on at least one feature map by using a height value and a width value of the at least one feature map in the feature map set and the number of channels corresponding to the feature map set as variables; and

obtaining the channel dimension variance based on the channel dimension mean and the at least one feature map.

Optionally, the normalizing the feature map set based on the batch coordinate dimension to obtain a batch coordinate dimension variance and a batch coordinate dimension mean includes:

obtaining the batch coordinate dimension mean based on the at least one feature map by using the height value and the width value of the at least one feature map in the feature map set and the amount of input data corresponding to the input data set as variables; and

obtaining the batch coordinate dimension variance based on the batch coordinate dimension mean and the at least one feature map.

Optionally, the normalizing a feature map set output by means of a network layer in the deep neural network from at least one dimension to obtain at least one dimension variance and at least one dimension mean includes:

normalizing the feature map set based on the spatial dimension to obtain a spatial dimension variance and a spatial dimension mean;

obtaining a channel dimension variance and a channel dimension mean corresponding to the channel dimension based on the spatial dimension variance and the spatial dimension mean; and

obtaining a batch coordinate dimension variance and a batch coordinate dimension mean corresponding to the batch coordinate dimension based on the spatial dimension variance and the spatial dimension mean.

Optionally, the normalizing the feature map set based on the spatial dimension to obtain a spatial dimension variance and a spatial dimension mean includes:

obtaining the spatial dimension mean based on at least one feature map by using the height value and the width value of the at least one feature map in the feature map set as variables; and

obtaining the spatial dimension variance based on the spatial dimension mean and the at least one feature map.

Optionally, the obtaining a channel dimension variance and a channel dimension mean corresponding to the channel dimension based on the spatial dimension variance and the spatial dimension mean includes:

obtaining the channel dimension mean based on the spatial dimension mean by using the number of channels corresponding to the feature map set as a variable; and

obtaining the channel dimension variance based on the spatial dimension mean, the spatial dimension variance, and the channel dimension mean by using the number of channels corresponding to the feature map set as the variable.

Optionally, the obtaining a batch coordinate dimension variance and a batch coordinate dimension mean corresponding to the batch coordinate dimension based on the spatial dimension variance and the spatial dimension mean includes:

obtaining the batch coordinate dimension mean based on the spatial dimension mean by using the amount of input data corresponding to the input data set as a variable; and

obtaining the batch coordinate dimension variance based on the spatial dimension mean, the spatial dimension variance, and the batch coordinate dimension mean by using the amount of input data corresponding to the input data set as the variable.

Optionally, the determining a normalized target feature map set based on the at least one dimension variance and the at least one dimension mean includes:

weighted-averaging the at least one dimension variance to obtain a normalized variance, and weighted-averaging the at least one dimension mean to obtain a normalized mean; and

determining the target feature map set based on the normalized variance and the normalized mean.

Optionally, the determining the target feature map set based on the normalized variance and the normalized mean includes:

processing the feature map set based on the normalized variance, the normalized mean, a scaling parameter, and a translation parameter to obtain the target feature map set.

Optionally, the method further includes:

determining at least one data result corresponding to the input data set based on the target feature map set.

Optionally, the input data is sample data having annotation information; and

the method further includes:

training the deep neural network based on a sample data set, the sample data set including at least one piece of sample data.

Optionally, the deep neural network includes at least one network layer and at least one normalization layer; and

the training the deep neural network based on a sample data set includes:

inputting the sample data set into the deep neural network, and outputting a sample feature map set by means of the network layer, the sample feature map set including at least one sample feature map;

normalizing, by means of the normalization layer, the sample feature map set from at least one dimension to obtain at least one sample dimension variance and at least one sample dimension mean;

determining a normalized prediction feature map set based on the at least one sample dimension variance and the at least one sample dimension mean;

determining a prediction result corresponding to the sample data based on the prediction feature map set; and

adjusting parameters of the at least one network layer and parameters of the at least one normalization layer based on the prediction result and the annotation information.

Optionally, the parameters of the normalization layer include at least one of: a weight value corresponding to the dimension, a scaling parameter, or a translation parameter.

Optionally, the weight value includes at least one of:

a spatial dimension weight value, a channel dimension weight value, or a batch coordinate dimension weight value.

Optionally, the normalizing, by the normalization layer, the sample feature map set from at least one dimension to obtain at least one sample dimension variance and at least one sample dimension mean includes:

normalizing the sample feature map set based on the spatial dimension to obtain a sample spatial dimension variance and a sample spatial dimension mean; and/or,

normalizing the sample feature map set based on the channel dimension to obtain a sample channel dimension variance and a sample channel dimension mean; and/or,

normalizing the sample feature map set based on the batch coordinate dimension to obtain a sample batch coordinate dimension variance and a sample batch coordinate dimension mean.

Optionally, the normalizing the sample feature map set based on the channel dimension to obtain a sample channel dimension variance and a sample channel dimension mean includes:

obtaining the sample channel dimension mean based on at least one sample feature map by using a height value and a width value of the at least one sample feature map in the sample feature map set and the number of channels corresponding to the sample feature map set as variables; and

obtaining the sample channel dimension variance based on the sample channel dimension mean and the at least one sample feature map.

Optionally, the normalizing the sample feature map set based on the batch coordinate dimension to obtain a sample batch coordinate dimension variance and a sample batch coordinate dimension mean includes:

obtaining the sample batch coordinate dimension mean based on the at least one sample feature map by using the height value and the width value of the at least one sample feature map in the sample feature map set and the amount of sample data corresponding to the sample data set as variables; and

obtaining the sample batch coordinate dimension variance based on the sample batch coordinate dimension mean and the at least one sample feature map.

Optionally, the normalizing, by the normalization layer, the sample feature map set from at least one dimension to obtain at least one sample dimension variance and at least one sample dimension mean includes:

normalizing the sample feature map set based on the spatial dimension to obtain a sample spatial dimension variance and a sample spatial dimension mean;

obtaining a sample channel dimension variance and a sample channel dimension mean corresponding to the channel dimension based on the sample spatial dimension variance and the sample spatial dimension mean; and

obtaining a sample batch coordinate dimension variance and a sample batch coordinate dimension mean corresponding to the batch coordinate dimension based on the sample spatial dimension variance and the sample spatial dimension mean.

Optionally, the normalizing the sample feature map set based on the spatial dimension to obtain a sample spatial dimension variance and a sample spatial dimension mean includes:

obtaining the sample spatial dimension mean based on at least one sample feature map by using the height value and the width value of the at least one sample feature map in the sample feature map set as variables; and

obtaining the sample spatial dimension variance based on the sample spatial dimension mean and the at least one sample feature map.

Optionally, the obtaining a sample channel dimension variance and a sample channel dimension mean corresponding to the channel dimension based on the sample spatial dimension variance and the sample spatial dimension mean includes:

obtaining the sample channel dimension mean based on the sample spatial dimension mean by using the number of channels corresponding to the sample feature map set as a variable; and

obtaining the sample channel dimension variance based on the sample spatial dimension mean, the sample spatial dimension variance, and the sample channel dimension mean by using the number of channels corresponding to the sample feature map set as the variable.

Optionally, the obtaining a sample batch coordinate dimension variance and a sample batch coordinate dimension mean corresponding to the batch coordinate dimension based on the sample spatial dimension variance and the sample spatial dimension mean includes:

obtaining the sample batch coordinate dimension mean based on the sample spatial dimension mean by using the amount of sample data corresponding to the sample data set as a variable; and

obtaining the sample batch coordinate dimension variance based on the sample spatial dimension mean, the sample spatial dimension variance, and the sample batch coordinate dimension mean by using the amount of sample data corresponding to the sample data set as the variable.

Optionally, the determining a normalized prediction feature map set based on the at least one sample dimension variance and the at least one sample dimension mean includes:

weighted-averaging the at least one sample dimension variance to obtain a sample normalized variance, and weighted-averaging the at least one sample dimension mean to obtain a sample normalized mean; and

processing the sample feature map set based on the sample normalized variance, the sample normalized mean, a scaling parameter, and a translation parameter to obtain the prediction feature map set.

According to another aspect of the embodiments of the present disclosure, provided is a normalization apparatus for a deep neural network, including:

an input unit, configured to input an input data set into a deep neural network, the input data set including at least one piece of input data;

a dimension normalization unit, configured to normalize a feature map set output by means of a network layer in the deep neural network from at least one dimension to obtain at least one dimension variance and at least one dimension mean, the feature map set including at least one feature map, the feature map set corresponding to at least one channel, and each channel corresponding to at least one feature map; and

a batch normalization unit, configured to determine a normalized target feature map set based on the at least one dimension variance and the at least one dimension mean.

Optionally, the dimension includes at least one of:

a spatial dimension, a channel dimension, or a batch coordinate dimension.

Optionally, the dimension normalization unit is configured to normalize the feature map set based on the spatial dimension to obtain a spatial dimension variance and a spatial dimension mean; and/or,

normalize the feature map set based on the channel dimension to obtain a channel dimension variance and a channel dimension mean; and/or,

normalize the feature map set based on the batch coordinate dimension to obtain a batch coordinate dimension variance and a batch coordinate dimension mean.

Optionally, when normalizing the feature map set based on the channel dimension to obtain a channel dimension variance and a channel dimension mean, the dimension normalization unit is specifically configured to obtain the channel dimension mean based on at least one feature map by using a height value and a width value of the at least one feature map in the feature map set and the number of channels corresponding to the feature map set as variables, and obtain the channel dimension variance based on the channel dimension mean and the at least one feature map.

Optionally, when normalizing the feature map set based on the batch coordinate dimension to obtain a batch coordinate dimension variance and a batch coordinate dimension mean, the dimension normalization unit is specifically configured to obtain the batch coordinate dimension mean based on the at least one feature map by using the height value and the width value of the at least one feature map in the feature map set and the amount of input data corresponding to the input data set as variables, and obtain the batch coordinate dimension variance based on the batch coordinate dimension mean and the at least one feature map.

Optionally, the dimension normalization unit is configured to normalize the feature map set based on the spatial dimension to obtain a spatial dimension variance and a spatial dimension mean, obtain a channel dimension variance and a channel dimension mean corresponding to the channel dimension based on the spatial dimension variance and the spatial dimension mean, and obtain a batch coordinate dimension variance and a batch coordinate dimension mean corresponding to the batch coordinate dimension based on the spatial dimension variance and the spatial dimension mean.

Optionally, when normalizing the feature map set based on the spatial dimension to obtain a spatial dimension variance and a spatial dimension mean, the dimension normalization unit is configured to obtain the spatial dimension mean based on at least one feature map by using the height value and the width value of the at least one feature map in the feature map set as variables, and obtain the spatial dimension variance based on the spatial dimension mean and the at least one feature map.

Optionally, when obtaining a channel dimension variance and a channel dimension mean corresponding to the channel dimension based on the spatial dimension variance and the spatial dimension mean, the dimension normalization unit is configured to obtain the channel dimension mean based on the spatial dimension mean by using the number of channels corresponding to the feature map set as a variable, and obtain the channel dimension variance based on the spatial dimension mean, the spatial dimension variance, and the channel dimension mean by using the number of channels corresponding to the feature map set as the variable.

Optionally, when obtaining a batch coordinate dimension variance and a batch coordinate dimension mean corresponding to the batch coordinate dimension based on the spatial dimension variance and the spatial dimension mean, the dimension normalization unit is configured to obtain the batch coordinate dimension mean based on the spatial dimension mean by using the amount of input data corresponding to the input data set as a variable, and obtain the batch coordinate dimension variance based on the spatial dimension mean, the spatial dimension variance, and the batch coordinate dimension mean by using the amount of input data corresponding to the input data set as the variable.

Optionally, when determining a normalized target feature map set based on the at least one dimension variance and the at least one dimension mean, the batch normalization unit is configured to weighted-average the at least one dimension variance to obtain a normalized variance and weighted-average the at least one dimension mean to obtain a normalized mean, and determine the target feature map set based on the normalized variance and the normalized mean.

Optionally, when determining the target feature map set based on the normalized variance and the normalized mean, the batch normalization unit is configured to process the feature map set based on the normalized variance, the normalized mean, a scaling parameter, and a translation parameter to obtain the target feature map set.

Optionally, the apparatus further includes:

a result determination unit, configured to determine at least one data result corresponding to the input data set based on the target feature map set.

Optionally, the input data is sample data having annotation information; and

the apparatus further includes:

a training unit, configured to train the deep neural network based on a sample data set, the sample data set including at least one piece of sample data.

Optionally, the deep neural network includes at least one network layer and at least one normalization layer; and

the input unit is further configured to input the sample data set into the deep neural network, and output a sample feature map set by means of the network layer, the sample feature map set including at least one sample feature map;

the dimension normalization unit is further configured to normalize, by means of the normalization layer, the sample feature map set from at least one dimension to obtain at least one sample dimension variance and at least one sample dimension mean;

the batch normalization unit is further configured to determine a normalized prediction feature map set based on the at least one sample dimension variance and the at least one sample dimension mean;

the result determination unit is further configured to determine a prediction result corresponding to the sample data based on the prediction feature map set; and

the training unit is configured to adjust parameters of the at least one network layer and parameters of the at least one normalization layer based on the prediction result and the annotation information.

Optionally, the parameters of the normalization layer include at least one of: a weight value corresponding to the dimension, a scaling parameter, or a translation parameter.

Optionally, the weight value includes at least one of:

a spatial dimension weight value, a channel dimension weight value, or a batch coordinate dimension weight value.

Optionally, the dimension normalization unit is specifically configured to normalize the sample feature map set based on the spatial dimension to obtain a sample spatial dimension variance and a sample spatial dimension mean; and/or,

normalize the sample feature map set based on the channel dimension to obtain a sample channel dimension variance and a sample channel dimension mean; and/or,

normalize the sample feature map set based on the batch coordinate dimension to obtain a sample batch coordinate dimension variance and a sample batch coordinate dimension mean.

Optionally, when normalizing the sample feature map set based on the channel dimension to obtain a sample channel dimension variance and a sample channel dimension mean, the dimension normalization unit is configured to obtain the sample channel dimension mean based on at least one sample feature map by using a height value and a width value of the at least one sample feature map in the sample feature map set and the number of channels corresponding to the sample feature map set as variables, and obtain the sample channel dimension variance based on the sample channel dimension mean and the at least one sample feature map.

Optionally, when normalizing the sample feature map set based on the batch coordinate dimension to obtain a sample batch coordinate dimension variance and a sample batch coordinate dimension mean, the dimension normalization unit is configured to obtain the sample batch coordinate dimension mean based on the at least one sample feature map by using the height value and the width value of the at least one sample feature map in the sample feature map set and the amount of sample data corresponding to the sample data set as variables, and obtain the sample batch coordinate dimension variance based on the sample batch coordinate dimension mean and the at least one sample feature map.

Optionally, the dimension normalization unit is configured to normalize the sample feature map set based on the spatial dimension to obtain a sample spatial dimension variance and a sample spatial dimension mean, obtain a sample channel dimension variance and a sample channel dimension mean corresponding to the channel dimension based on the sample spatial dimension variance and the sample spatial dimension mean, and obtain a sample batch coordinate dimension variance and a sample batch coordinate dimension mean corresponding to the batch coordinate dimension based on the sample spatial dimension variance and the sample spatial dimension mean.

Optionally, when normalizing the sample feature map set based on the spatial dimension to obtain a sample spatial dimension variance and a sample spatial dimension mean, the dimension normalization unit is configured to obtain the sample spatial dimension mean based on at least one sample feature map by using the height value and the width value of the at least one sample feature map in the sample feature map set as variables, and obtain the sample spatial dimension variance based on the sample spatial dimension mean and the at least one sample feature map.

Optionally, when obtaining a sample channel dimension variance and a sample channel dimension mean corresponding to the channel dimension based on the sample spatial dimension variance and the sample spatial dimension mean, the dimension normalization unit is configured to obtain the sample channel dimension mean based on the sample spatial dimension mean by using the number of channels corresponding to the sample feature map set as a variable, and obtain the sample channel dimension variance based on the sample spatial dimension mean, the sample spatial dimension variance, and the sample channel dimension mean by using the number of channels corresponding to the sample feature map set as the variable.

Optionally, when obtaining a sample batch coordinate dimension variance and a sample batch coordinate dimension mean corresponding to the batch coordinate dimension based on the sample spatial dimension variance and the sample spatial dimension mean, the dimension normalization unit is configured to obtain the sample batch coordinate dimension mean based on the sample spatial dimension mean by using the amount of sample data corresponding to the sample data set as a variable, and obtain the sample batch coordinate dimension variance based on the sample spatial dimension mean, the sample spatial dimension variance, and the sample batch coordinate dimension mean by using the amount of sample data corresponding to the sample data set as the variable.

Optionally, the batch normalization unit is configured to weighted-average the at least one sample dimension variance to obtain a sample normalized variance, and weighted-average the at least one sample dimension mean to obtain a sample normalized mean; and process the sample feature map set based on the sample normalized variance, the sample normalized mean, a scaling parameter, and a translation parameter to obtain the prediction feature map set.

According to another aspect of the embodiments of the present disclosure, provided is an electronic device, including a processor, where the processor includes the normalization apparatus for a deep neural network according to any one of the foregoing embodiments.

According to still another aspect of the embodiments of the present disclosure, provided is an electronic device, including: a memory configured to store executable instructions; and

a processor configured to communicate with the memory to execute the executable instructions so as to complete operations of the normalization method for a deep neural network according to any one of the foregoing embodiments.

According to yet another aspect of the embodiments of the present disclosure, provided is a computer readable storage medium configured to store computer readable instructions, where when the instructions are executed, operations of the normalization method for a deep neural network according to any one of the foregoing embodiments are implemented.

According to yet another aspect of the embodiments of the present disclosure, a computer program product is provided, including computer readable codes, where when the computer readable codes run in a device, a processor in the device executes instructions for implementing the normalization method for a deep neural network according to any one of the foregoing embodiments.

Based on normalization methods and apparatuses for a deep neural network, devices, and storage media provided in the foregoing embodiments of the present disclosure, an input data set is input into a deep neural network; a feature map set output by means of a network layer in the deep neural network is normalized from at least one dimension to obtain at least one dimension variance and at least one dimension mean; and a normalized target feature map set is determined based on the at least one dimension variance and the at least one dimension mean. Normalization is performed along at least one dimension so that statistics information of each dimension of a normalization operation is covered, thereby ensuring good robustness of statistics in each dimension without excessively depending on the batch size.

By means of the accompanying drawings and embodiments, the technical solutions of the present disclosure are further described below in detail.

### BRIEF DESCRIPTION OF THE DRAWINGS

The drawings constituting a part of the description describe embodiments of the present disclosure, and are used for explaining the principles of the present disclosure in combination of the description.

With reference to the accompanying drawings, according to the detailed description below, the present disclosure can be understood more clearly, where:

FIG. 1 is a flowchart of one embodiment of a normalization method for a deep neural network according to the present disclosure.

FIG. 2 is an exemplary diagram of one example of a normalization method for a deep neural network according to embodiments of the present disclosure.

FIG. 3 is a schematic structural diagram of one example of a deep neural network in the normalization method for a deep neural network according to the present disclosure.

FIG. 4 is a schematic structural diagram of one embodiment of a normalization apparatus for a deep neural network according to the present disclosure.

FIG. 5 is a schematic structural diagram of an electronic device, which may be a terminal device or a server, suitable for implementing the embodiments of the present disclosure.

### DETAILED DESCRIPTIONS

Exemplary embodiments of the present disclosure are described in detail with reference to the accompany drawings now. It should be noted that, unless otherwise stated specifically, relative arrangement of the components and steps, the numerical expressions, and the values set forth in the embodiments are not intended to limit the scope of the present disclosure.

In addition, it should be understood that, for ease of description, the size of each section shown in the accompanying drawings is not drawn in an actual proportion.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the description in appropriate situations.

It should be noted that similar reference numerals and letters in the following accompanying drawings represent similar items. Therefore, once an item is defined in an accompanying drawing, the item does not need to be further discussed in the subsequent accompanying drawings.

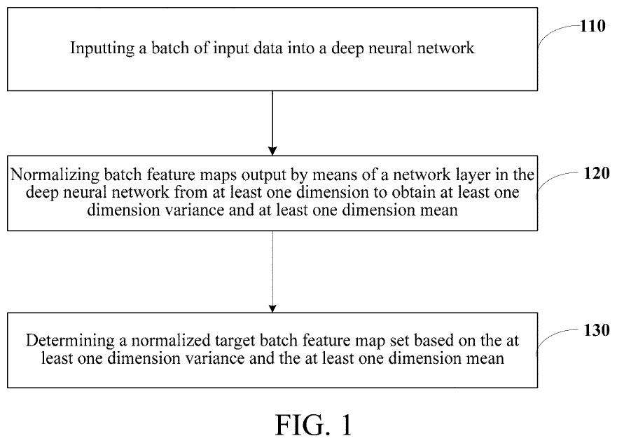

FIG. 1 is a flowchart of one embodiment of a normalization method for a deep neural network according to the present disclosure. As shown in FIG. 1, the method of this embodiment includes the following steps.

At step 110, an input data set is input into a deep neural network.

The input data set includes at least one piece of input data; the deep neural network may include, but is not limited to: a Convolutional Neural Network (CNN), a Recurrent Neural Network (RNN), a Long Short-Term Memory (LSTM) network, or a neural network capable of achieving various vision tasks, such as image classification (ImageNet), target detection and segmentation (COCO), video identification (Kinetics), image stylization, and handwriting generation.

At step 120, a feature map set output by means of a network layer in the deep neural network is normalized from at least one dimension to obtain at least one dimension variance and at least one dimension mean.

The feature map set includes at least one feature map, the feature map set corresponds to at least one channel, and each channel corresponds to at least one feature map. For example, if the network layer is a convolutional layer, the number of channels corresponding to the generated feature map set is identical to the number of convolution kernels, and if the convolutional layer has two convolution kernels, the feature map set corresponding to two channels is generated. Optionally, the dimension may include, but is not limited to, at least one of: a spatial dimension, a channel dimension, or a batch coordinate dimension.

At step 130, a normalized target feature map set is determined based on the at least one dimension variance and the at least one dimension mean.

Based on the normalization method for a deep neural network provided in the foregoing embodiment of the present disclosure, the input data set is input into the deep neural network; the feature map set output by means of the network layer in the deep neural network is normalized from at least one dimension to obtain at least one dimension variance and at least one dimension mean; and the normalized target feature map set is determined based on the at least one dimension variance and the at least one dimension mean. Normalization is performed along at least one dimension so that statistics information of each dimension of a normalization operation is covered, thereby ensuring good robustness of statistics in each dimension without excessively depending on the batch size.

In one or more optional embodiments, step 120 may include:

normalizing the feature map set based on the spatial dimension to obtain a spatial dimension variance and a spatial dimension mean; and/or,

normalizing the feature map set based on the channel dimension to obtain a channel dimension variance and a channel dimension mean; and/or,

normalizing the feature map set based on the batch coordinate dimension to obtain a batch coordinate dimension variance and a batch coordinate dimension mean.

In the embodiments, arithmetic means including three dimension statistics are calculated along different axes (a batch coordinate axis, a channel axis, and a space axis) of a feature map to diversify statistic calculation dimensions of a normalization operation, so that batch statistics maintains the robustness without being excessively sensitive to the batch size. On the other hand, weighting coefficients of different dimension statistics are learned, so that for a single normalization layer, the weight of each dimension statistic can be independently selected without manually designing and combining a normalization operation mode with optimal performance.

See formula (1) for calculation methods of a mean and a variance of each dimension:

$${μ}_{k} = \frac{1}{\vert {I}_{k} \vert} {\sum }_{( n , c , i , j ) ∈ {I}_{k}} {h}_{n c i j} , {σ}_{k}^{2} = \frac{1}{\vert {I}_{k} \vert} {\sum }_{( n , c , i , j ) ∈ {I}_{k}} {( {h}_{n c i j} - {μ}_{k} )}^{2} \qquad Formula ( 1 )$$

μₖ represents the mean; σₖ² represents the variance; h_{ncij} is any four-dimensional (N, H, W, C) feature map and is an input of the normalization layer, where N represents the amount of data of a batch of data, H and W respectively represent a height value and a width value of one feature map, and C represents the number of channels corresponding to a feature map set (i.e., the number of channels corresponding to the network layer in step 120); k∈Ω, and Ω={BN,IN,LN}, where BN, IN, and LN are respectively batch normalization, instance normalization, and layer normalization for statistic calculation along the batch axis N, the space axis H×W, and the channel axis C. Calculation methods for three dimensions are similar; however, pixel ranges of the statistics are different. Iₖ is a pixel range of statistical calculation of each dimension, and h_{ncij} is a point in.

Optionally, the normalizing the feature map set based on the spatial dimension to obtain a spatial dimension variance and a spatial dimension mean includes:

obtaining the spatial dimension mean based on at least one feature map by using the height value and the width value of the at least one feature map in the feature map set as variables; and

obtaining the spatial dimension variance based on the spatial dimension mean and the at least one feature map.

The pixel range corresponding to the spatial dimension changing along with the space axis is represented as Iᵢₙ, where Iᵢₙ={(i,j)|i∈[1, H], j∈[1×W]}, where i and j are both positive integers, represent changes in processes of calculating the spatial dimension variance and the spatial dimension mean, and are the height value and the width value of the feature map.

Optionally, the normalizing the feature map set based on the channel dimension to obtain a channel dimension variance and a channel dimension mean includes:

obtaining the channel dimension mean based on the at least one feature map by using the height value and the width value of the at least one feature map in the feature map set and the number of channels corresponding to the feature map set as variables; and

obtaining the spatial dimension variance based on the spatial dimension mean and the at least one feature map.

The pixel range corresponding to the channel dimension changing along with the channel axis is represented as Iₗₙ, where Iₗₙ={(c, i, j)|c∈[1, C], i∈[1, H], j∈[1×W]}, where c is a positive integer, and i, j, and c represent changes in processes of calculating the channel dimension variance and the channel dimension mean, and are the height value and the width value of the feature map and the number of channels.

Optionally, the normalizing the feature map set based on the batch coordinate dimension to obtain a batch coordinate dimension variance and a batch coordinate dimension mean includes:

obtaining the batch coordinate dimension mean based on the at least one feature map by using the height value and the width value of the at least one feature map in the feature map set and the amount of input data corresponding to the input data set as variables; and

obtaining the batch coordinate dimension variance based on the batch coordinate dimension mean and the at least one feature map.

The pixel range corresponding to the batch coordinate dimension changing along with the batch coordinate axis is represented as I_{bn}, where I_{bn}={(n, i, j)|n∈[1, N], i∈[1, H], j∈[1×W]}, where n is a positive integer, and i, j, and n represent changes in processes of calculating the batch coordinate dimension variance and the batch coordinate dimension mean, and are the height value and the width value of the feature map and the amount of data of the input data set.

In one or more optional embodiments, step 120 may include:

normalizing the feature map set based on the spatial dimension to obtain a spatial dimension variance and a spatial dimension mean;

obtaining a channel dimension variance and a channel dimension mean corresponding to the channel dimension based on the spatial dimension variance and the spatial dimension mean; and

obtaining a batch coordinate dimension variance and a batch coordinate dimension mean corresponding to the batch coordinate dimension based on the spatial dimension variance and the spatial dimension mean.

The method of calculating the mean μₖ and the variance σₖ directly according to formula (1) brings about a large amount of redundant calculation; moreover, the three dimension statistics are dependent on one another. Therefore, in the embodiments, the statistics are calculated by means of the relationship among the dimensions by first calculating the spatial dimension variance and the spatial dimension mean and then calculating the means and variances on the channel dimension and the batch coordinate dimension based on the spatial dimension variance and the spatial dimension mean, thereby reducing the redundancy.

Optionally, the normalizing the feature map set based on the spatial dimension to obtain a spatial dimension variance and a spatial dimension mean includes:

obtaining the spatial dimension mean based on at least one feature map by using a height value and a width value of the at least one feature map in the feature map set as variables; and

obtaining the spatial dimension variance based on the spatial dimension mean and the at least one feature map.

The calculation for the spatial dimension variance and the spatial dimension mean is identical to that in the foregoing other embodiments, and the height value and the width value of a feature map are used as the variables and are then brought into formula (1) to obtain formula (2):

$${μ}_{i n} = \frac{1}{H W} {\sum }_{i , j}^{H , W} {h}_{n c i j} , {σ}_{i n}^{2} = \frac{1}{H W} {\sum }_{i , j}^{H , W} {( {h}_{n c i j} - {μ}_{i n} )}^{2} \qquad Formula ( 2 )$$

μᵢₙ represents the spatial dimension mean, and σᵢₙ² represents the spatial dimension variance. The spatial dimension variance and the spatial dimension mean are calculated through formula (2).

Optionally, the obtaining a channel dimension variance and a channel dimension mean corresponding to the channel dimension based on the spatial dimension variance and the spatial dimension mean includes:

obtaining the channel dimension mean based on the spatial dimension mean by using the number of channels corresponding to the feature map set as a variable; and

obtaining the channel dimension variance based on the spatial dimension mean, the spatial dimension variance, and the channel dimension mean by using the number of channels corresponding to the feature map set as the variable.

In the case that the spatial dimension variance and the spatial dimension mean are known, the channel dimension variance and the channel dimension mean can be calculated based on formula (3):

$${μ}_{l n} = \frac{1}{C} {\sum }_{c = 1}^{C} {μ}_{i n} , {σ}_{l n}^{2} = \frac{1}{C} {\sum }_{c = 1}^{C} ( {σ}_{i n}^{2} + {μ}_{i n}^{2} ) - {μ}_{l n}^{2} \qquad Formula ( 3 )$$

μₗₙ represents the channel dimension mean, and σₗₙ² represents the channel dimension variance. In formula (3), the variable is just the number of channels, and in this case, the amount of calculation is reduced and the processing speed is improved.

Optionally, the obtaining a batch coordinate dimension variance and a batch coordinate dimension mean corresponding to the batch coordinate dimension based on the spatial dimension variance and the spatial dimension mean includes:

obtaining the batch coordinate dimension mean based on the spatial dimension mean by using the amount of input data corresponding to the input data set as a variable; and

obtaining the batch coordinate dimension variance based on the spatial dimension mean, the spatial dimension variance, and the batch coordinate dimension mean by using the amount of input data corresponding to the input data set as the variable.

In the case that the spatial dimension variance and the spatial dimension mean are known, the batch coordinate dimension variance and the batch coordinate dimension mean can be calculated based on formula (4):

$${μ}_{b n} = \frac{1}{N} {\sum }_{n = 1}^{N} {μ}_{i n} , {σ}_{b n}^{2} = \frac{1}{N} {\sum }_{n = 1}^{N} ( {σ}_{i n}^{2} + {μ}_{i n}^{2} ) - {μ}_{b n}^{2} \qquad Formula ( 4 )$$

μ_{bn} represents the batch coordinate dimension mean, and σ_{bn}² represents the batch coordinate dimension variance. In formula (4), the variable is just the amount of input data corresponding to the input data set, so that the amount of calculation is reduced and the processing speed is improved.

After the spatial dimension variance and the spatial dimension mean are obtained, the channel dimension variance and the channel dimension mean can be calculated first, or the batch coordinate dimension variance and the batch coordinate dimension mean can be calculated first, where the order is not distinguished.

In one or more optional embodiments, step 130 may include:

weighted-averaging the at least one dimension variance to obtain a normalized variance, and weighted-averaging the at least one dimension mean to obtain a normalized mean; and

determining the target feature map set based on the normalized variance and the normalized mean.

In the embodiments, the feature map set is processed by means of the normalized variance and the normalized mean to obtain the target feature map set. Optionally, a difference between each feature map in the feature map set and the normalized mean is calculated, and the difference is divided by the normalized variance to obtain a target feature map so as to obtain the target feature map set.

Optionally, the determining the target feature map set based on the normalized variance and the normalized mean includes:

processing the feature map set based on the normalized variance, the normalized mean, a scaling parameter, and a translation parameter to obtain the target feature map set.

In the embodiments, an adaptive normalization formula is shown as formula (5):

$${\hat{h}}_{n c i j} = γ \frac{{h}_{n c i j} - {Σ}_{k ∈ Ω} {ω}_{k} {μ}_{k}}{\sqrt{{Σ}_{k ∈ Ω} {ω}_{k} {σ}_{k}^{2} + ϵ}} + β \qquad Formula ( 5 )$$

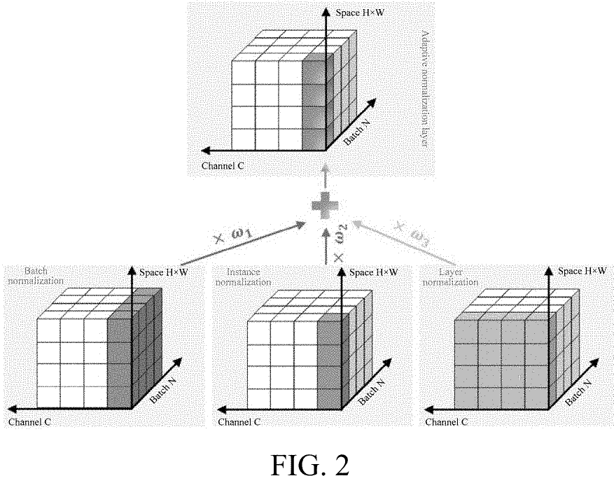

Any four-dimensional (N, H, W, C) feature map h_{ncij} is used as the input, an adaptive normalization operation is performed on each pixel point of the feature map, and a feature map ĥ_{ncij} of the same dimension is output. n∈[1,N], where N presents a sample amount in a small batch; c∈[1, C], where C is the number of channels of the feature map; and i∈[1, H] and j∈[1, W], where H and W are respectively the height value and the width value on each of the channel and spatial dimensions. See formula (5) for the adaptive normalization method calculation. γ and β are respectively conventional scaling and translation parameters, and ϵ is a small constant for preventing numerical instability. For the normalization operation on each pixel point, the mean μ is equal to kΣ_{k=Ω}ωₖμₖ and the variance σ is equal to Σ_{k∈Ω}ωₖσₖ², where ωₖ represents a dimension weight value corresponding to the mean or the variance of a different dimension. Moreover, the mean and variance calculation is jointly determined by the means and variances of three dimensions (the spatial dimension, the channel space, and the batch coordinate dimension), i.e., Ω={BN, IN, LN}, where BN, IN, and LN are respectively batch normalization, instance normalization, and layer normalization for statistic calculation along the batch axis N, the space axis H×W, and the channel axis C. As shown in FIG. 2, FIG. 2 is an exemplary diagram of one example of a normalization method for a deep neural network according to embodiments of the present disclosure.

In one or more optional embodiments, the method may further include:

determining at least one data result corresponding to the input data set based on the target feature map set.

The normalization operation is based on the feature map output by means of the network layer; the feature map set obtained by the deep neural network is normalized and then continues to be processed to obtain the data result; for deep neural networks having different tasks, different data results (such as a classification result, a segmentation result, and an identification result) are output.

In one or more optional embodiments, the input data is sample data having annotation information; and

The method according to the embodiments of the present disclosure may further include:

training the deep neural network based on a sample data set.

The sample data set includes at least one piece of sample data; normalization is performed from at least one dimension; parameters in the normalization layer of the deep neural network need to be trained to obtain a feature map with a better normalization effect; the addition of the normalization layer in the deep neural network for training can make the training converged more quickly and achieve the better training effect.

Optionally, the deep neural network includes at least one network layer and at least one normalization layer.

In the embodiments of the present disclosure, a respective normalization operation mode is selected for each normalization layer of a network. The normalization method provided in the embodiments of the present disclosure is applied to all normalization layers of the entire deep neural network, so that each normalization layer of the network can select, by means of learning in a more sensitive manner, normalization statistics favorable for respective feature expression, and it is verified that different normalization operation modes are selected in different network depths due to different visual representations.

The training the deep neural network based on a sample data set includes:

inputting the sample data set into the deep neural network, and outputting a sample feature map set by means of the network layer, the sample feature map set including at least one sample feature map;

normalizing, by means of the normalization layer, the sample feature map set from at least one dimension to obtain at least one sample dimension variance and at least one sample dimension mean;

determining a normalized prediction feature map set based on the at least one sample dimension variance and the at least one sample dimension mean;

determining a prediction result corresponding to the sample data based on the prediction feature map set; and

adjusting parameters of the at least one network layer and parameters of the at least one normalization layer based on the prediction result and the annotation information.

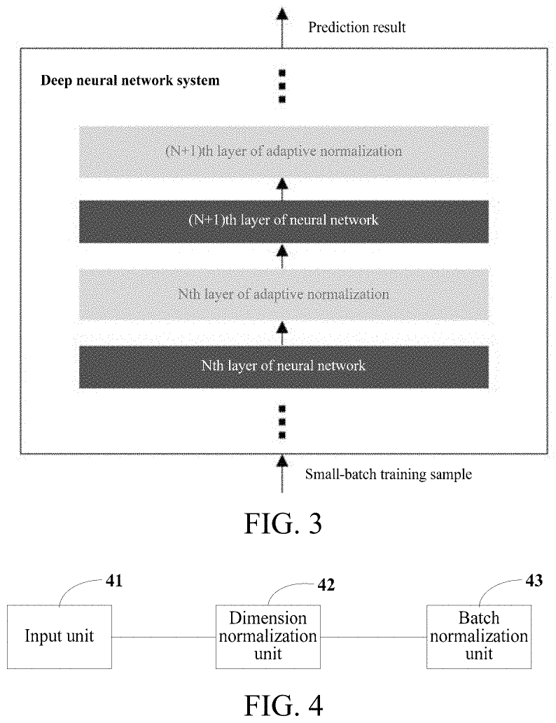

Optionally, the normalization layer is provided behind the network layer. FIG. 3 is a schematic structural diagram of one example of a deep neural network in the normalization method for a deep neural network according to the present disclosure. As shown in FIG. 3, a small batch of sample data is used as the input, and the prediction result for the batch of sample data is output by means of multiple layers of neural networks. Moreover, the normalization layer is added behind each layer of neural network to perform the adaptive normalization operation on each layer of feature map, so as to accelerate network training convergence and improve the model precision.

Optionally, the normalization method can be embedded into various deep neural network models (such as ResNet50, VGG16, and LSTM) to be applied to various vision tasks (such as image classification, target detection and segmentation, image stylization, and handwriting generation). Compared with an existing normalization method, the normalization method provided in the embodiments of the present disclosure has greater versatility and can yield more effective results on different vision tasks.

Optionally, the parameters of the normalization layer may include, but is not limited to, at least one of: a weight value corresponding to the dimension, a scaling parameter, or a translation parameter.

Optionally, the weight value includes at least one of: a spatial dimension weight value, a channel dimension weight value, or a batch coordinate dimension weight value.

The weight value corresponding to the dimension is a weight value corresponding to each dimension, and respectively has three weighting coefficients for three dimensional statistics, where the number can also be expanded as six, and each mean and variance has a different coefficient. On the other hand, the adaptive normalization method introduced as above relates to sharing the weighting coefficients on all channels; and the channels can also be grouped, so that the channels in each group share the coefficients, and each channel can even learn the weighting coefficient of a sub-set. In conclusion, the adaptive normalization method can be expanded, so as to replace any existing manually designed normalization method by means of different weighted combination modes of the different dimension statistics.

Optionally, the normalizing, by means of the normalization layer, the sample feature map set from at least one dimension to obtain at least one sample dimension variance and at least one sample dimension mean includes:

normalizing the sample feature map set based on the spatial dimension to obtain a sample spatial dimension variance and a sample spatial dimension mean; and/or,

normalizing the sample feature map set based on the channel dimension to obtain a sample channel dimension variance and a sample channel dimension mean; and/or,

normalizing the sample feature map set based on the batch coordinate dimension to obtain a sample batch coordinate dimension variance and a sample batch coordinate dimension mean.

In the embodiments, the sample feature map set is normalized from at least one dimension, thereby overcoming the extreme dependency of an existing batch normalization method on the batch size or other dimensions due to statistic calculation on the batch dimension and also overcoming the problem of limited effectiveness of an existing batch normalization method on different tasks of different models. In the embodiments, the arithmetic means including three dimension statistics are calculated along at least one space coordinate axis, so that the statistics information of each dimension of the normalization operation is covered, and compared with the previous technologies, the statistics on each dimension has good robustness without excessively depending on the batch size.

Optionally, the normalizing the sample feature map set based on the spatial dimension to obtain a sample spatial dimension variance and a sample spatial dimension mean includes:

obtaining the sample spatial dimension mean based on at least one sample feature map by using a height value and a width value of the at least one sample feature map in the sample feature map set as variables; and

obtaining the sample spatial dimension variance based on the sample spatial dimension mean and the at least one sample feature map.

Optionally, the normalizing the sample feature map set based on the channel dimension to obtain a sample channel dimension variance and a sample channel dimension mean includes:

obtaining the sample channel dimension mean based on the at least one sample feature map by using the height value and the width value of the at least one sample feature map in the sample feature map set and the number of channels corresponding to the sample feature map set as variables; and

obtaining the sample channel dimension variance based on the sample channel dimension mean and the at least one sample feature map.

Optionally, the normalizing the sample feature map set based on the batch coordinate dimension to obtain a sample batch coordinate dimension variance and a sample batch coordinate dimension mean includes:

obtaining the sample batch coordinate dimension mean based on the at least one sample feature map by using the height value and the width value of the at least one sample feature map in the sample feature map set and the amount of sample data corresponding to the sample data set as variables; and

obtaining the sample batch coordinate dimension variance based on the sample batch coordinate dimension mean and the at least one sample feature map.

In the embodiments, the calculation methods for the variances and the means of the spatial dimension, the channel dimension, and the batch coordinate dimension and the prediction processes thereof are identical, and can both be achieved based on the calculation of formula (1), i.e., the means and the variances of different dimensions are calculated, and weighted averaging is performed based on the calculated means and variances so as to obtain the mean and the variance corresponding to the sample feature image; then the mean and the variance are brought into formula (5) to obtain the prediction feature map set. Optionally, the determining a normalized prediction feature map set based on the at least one sample dimension variance and the at least one sample dimension mean includes: weighted-averaging the at least one sample dimension variance to obtain a sample normalized variance, and weighted-averaging the at least one sample dimension mean to obtain a sample normalized mean; and processing the sample feature map set based on the sample normalized variance, the sample normalized mean, a scaling parameter, and a translation parameter to obtain the prediction feature map set.

In one or more optional embodiments, the normalizing, by means of the normalization layer, the sample feature map set from at least one dimension to obtain at least one sample dimension variance and at least one sample dimension mean includes:

normalizing the sample feature map set based on the spatial dimension to obtain a sample spatial dimension variance and a sample spatial dimension mean, where

optionally, the sample spatial dimension mean is obtained based on at least one sample feature map by using the height value and the width value of the at least one sample feature map in the sample feature map set as variables, and

the sample spatial dimension variance is obtained based on the sample spatial dimension mean and the at least one sample feature map;

obtaining a sample channel dimension variance and a sample channel dimension mean corresponding to the channel dimension based on the sample spatial dimension variance and the sample spatial dimension mean, where

optionally, the sample channel dimension mean is obtained based on the sample spatial dimension mean by using the number of channels corresponding to the sample feature map set as a variable, and

the sample channel dimension variance is obtained based on the sample spatial dimension mean, the sample spatial dimension variance, and the sample channel dimension mean by using the number of channels corresponding to the sample feature map set as the variable; and

obtaining a sample batch coordinate dimension variance and a sample batch coordinate dimension mean corresponding to the batch coordinate dimension based on the sample spatial dimension variance and the sample spatial dimension mean, where

optionally, the sample batch coordinate dimension mean is obtained based on the sample spatial dimension mean by using the amount of sample data corresponding to the sample data set as a variable, and

the sample batch coordinate dimension variance is obtained based on the sample spatial dimension mean, the sample spatial dimension variance, and the sample batch coordinate dimension mean by using the amount of sample data corresponding to the sample data set as the variable.

The method of calculating the mean μₖ and the variance σₖ directly according to formula (1) brings about a large amount of redundant calculation; moreover, the three dimension statistics are dependent on one another. Therefore, in the embodiments, the statistics are calculated by means of the relationship among the dimensions by first calculating the spatial dimension variance and the spatial dimension mean and then calculating the means and variances on the channel dimension and the batch coordinate dimension based on the spatial dimension variance and the spatial dimension mean, thereby reducing the redundancy.

In one or more optional embodiments, the determining a normalized prediction feature map set based on the at least one sample dimension variance and the at least one sample dimension mean includes:

weighted-averaging the at least one sample dimension variance to obtain a sample normalized variance, and weighted-averaging the at least one sample dimension mean to obtain a sample normalized mean; and

processing the sample feature map set based on the sample normalized variance, the sample normalized mean, a scaling parameter, and a translation parameter to obtain the prediction feature map set.

Optionally, the weight value, the scaling parameter, and the translation parameter for weighted-averaging are all parameters required for adjusting the normalization layer according to the embodiments of the present disclosure. Weighting coefficients of different dimension statistics are learned by means of training, so that for a single normalization layer, the weight of each dimension statistic can be independently selected without manually designing and combining a normalization operation mode with optimal performance.

Optionally, the at least one sample dimension variance includes: the sample spatial dimension variance, the sample channel dimension variance, and the sample batch coordinate dimension variance; and

the weighted-averaging the at least one sample dimension variance to obtain a sample normalized variance includes:

summing a product of the sample spatial dimension variance and the spatial dimension weight value, a product of the sample channel dimension variance and the channel dimension weight value, and a product of the sample batch coordinate dimension variance and the batch coordinate dimension weight value, and obtaining the sample normalized variance based on the obtained sum.

Optionally, the at least one sample dimension mean includes: the sample spatial dimension mean, the sample channel dimension mean, and the sample batch coordinate dimension mean; and

the weighted-averaging the at least one sample dimension mean to obtain a sample normalized mean includes:

summing a product of the sample spatial dimension mean and the spatial dimension weight value, a product of the sample channel dimension mean and the channel dimension weight value, and a product of the sample batch coordinate dimension mean and the batch coordinate dimension weight value, and obtaining the sample normalized mean based on the obtained sum.

Optionally, the dimension weight values of the statistics (the mean and the variance) of each dimension can be calculated through formula (6):

$${ω}_{k} = \frac{{e}^{{λ}_{k}}}{{Σ}_{z ∈ \{ b n , i n , l n \}} {e}^{{λ}_{Z}}} , k ∈ \{ bn , in , ln \} \qquad Formula ( 6 )$$

ωₖ represents a dimension weight value corresponding to the mean or the variance of a different dimension; λₖ is a network parameter corresponding to the three dimension statistics, the parameter is subjected to learning for optimization during back propagation, and the dimension weight value ωₖ is optimized by optimizing λₖ; and Σ_{z∈{bn,in,ln}}e^{λ}^{_{z}} represents the calculation of the sum of corresponding e^{λ}^{_{z}} when z is valued as bn, in. and In. An optimization parameter can be normalized by using a softmax function to calculate final weighting coefficients of the statistics (the dimension weight values). In addition, the sum of all the weighting coefficients ωₖ is 1, and the value of each weighting coefficient ωₖ is between 0 and 1.

In the embodiments, the sample normalized mean and the sample normalized variance are obtained by calculating data averages of the statistics of each dimension. Optionally, the weight value corresponding to the dimension is a weight value corresponding to each dimension, and respectively has three weighting coefficients for three dimensional statistics, where the number can also be expanded as six, and each mean and variance has a different coefficient. On the other hand, the adaptive normalization method introduced as above relates to sharing the weighting coefficients on all channels; and the channels can also be grouped, so that the channels in each group share the coefficients, and each channel can even learn the weighting coefficient of a sub-set. In conclusion, the adaptive normalization method can be expanded, so as to replace any existing manually designed normalization method by means of different weighted combination modes of the different dimension statistics. The adaptive normalization method can achieve the calculation of the statistics information of multiple dimensions of the neural network visual representations, and can replace any existing manually and finely designed normalization method by means of combination modes of different weighting coefficients. On the other hand, the adaptive normalization method can achieve the learning of different weighting coefficients by statistics of different dimensions, so as to integrate more normalization technologies that are convenient to implement.

The normalization methods provided in the embodiments of the present disclosure achieve adaptive selection to normalization modes in a network model, assist in quick model convergence, and improve a product model effect; also have the advantage of strong versatility, and thus can apply to various network models and vision tasks; can be easily and effectively applied to the Convolutional Neural network (CNN), the Recurrent Neural Network (RNN), or the Long Short-Term Memory (LSTM) network to achieve excellent effects on various vision tasks, such as image classification (ImageNet), target detection and segmentation (COCO), video identification (Kinetics), image stylization, and handwriting generation; and subsequently, can further be applied to a Generative Adversarial Network (GAN) for high-resolution image synthesis.

The normalization methods provided in the embodiments of the present disclosure can be applied to application scenarios of any product model that needs the normalization layer to assist in optimizing network training and any technology that requires image identification, target detection, target segmentation, and image stylization.

A person of ordinary skill in the art may understand that: all or some steps for implementing the foregoing method embodiments are achieved by a program by instructing related hardware; the foregoing program can be stored in a computer readable storage medium; when the program is executed, steps including the foregoing method embodiments are executed. Moreover, the foregoing storage medium includes: various media capable of storing program codes, such as ROM, RAM, a magnetic disk, or an optical disk.

FIG. 4 is a schematic structural diagram of one embodiment of a normalization apparatus for a deep neural network according to the present disclosure. The apparatus of this embodiment is configured to implement the foregoing method embodiments of the present disclosure. As shown in FIG. 4, the apparatus of this embodiment includes:

an input unit 41 configured to input an input data set into a deep neural network.

The input data set includes at least one piece of input data; the deep neural network may include, but is not limited to: a Convolutional Neural Network (CNN), a Recurrent Neural Network (RNN), a Long Short-Term Memory (TSTM) network, or a neural network capable of achieving various vision tasks, such as image classification (ImageNet), target detection and segmentation (COCO), video identification (Kinetics), image stylization, and handwriting generation.

A dimension normalization unit 42 configured to normalize a feature map set output by means of a network layer in the deep neural network from at least one dimension to obtain at least one dimension variance and at least one dimension mean.

The feature map set includes at least one feature map, the feature map set corresponds to at least one channel, and each channel corresponds to at least one feature map. Optionally, the dimension may include, but is not limited to, at least one of: a spatial dimension, a channel dimension, or a batch coordinate dimension.

A batch normalization unit 43 configured to determine a normalized target feature map set based on the at least one dimension variance and the at least one dimension mean.

Based on the normalization apparatus for a deep neural network provided in the foregoing embodiment of the present disclosure, the input data set is input into the deep neural network; the feature map set output by means of the network layer in the deep neural network is normalized from at least one dimension to obtain at least one dimension variance and at least one dimension mean; and the normalized target feature map set is determined based on the at least one dimension variance and the at least one dimension mean. Normalization is performed along at least one dimension so that statistics information of each dimension of a normalization operation is covered, thereby ensuring good robustness of statistics in each dimension without excessively depending on the batch size.

In one or more optional embodiments, the dimension normalization unit 42 is configured to normalize the feature map set based on the spatial dimension to obtain a spatial dimension variance and a spatial dimension mean; and/or,

normalize the feature map set based on the channel dimension to obtain a channel dimension variance and a channel dimension mean; and/or,

normalize the feature map set based on the batch coordinate dimension to obtain a batch coordinate dimension variance and a batch coordinate dimension mean.

In the embodiments, arithmetic means including three dimension statistics are calculated along different axes (a batch coordinate axis, a channel axis, and a space axis) of a feature map to diversify statistic calculation dimensions of a normalization operation, so that batch statistics maintains the robustness without being excessively sensitive to the batch size. On the other hand, weighting coefficients of different dimension statistics are learned, so that for a single normalization layer, the weight of each dimension statistic can be independently selected without manually designing and combining a normalization operation mode with optimal performance. A mean μₖ and a variance σₖ of each dimension can be calculated through formula (1).

Optionally, when normalizing the feature map set based on the spatial dimension to obtain a spatial dimension variance and a spatial dimension mean, the dimension normalization unit 42 is configured to obtain the spatial dimension mean based on at least one feature map by using a height value and a width value of the at least one feature map in the feature map set as variables, and obtain the spatial dimension variance based on the spatial dimension mean and the at least one feature map.

Optionally, when normalizing the feature map set based on the channel dimension to obtain a channel dimension variance and a channel dimension mean, the dimension normalization unit 42 is specifically configured to obtain the channel dimension mean based on the at least one feature map by using the height value and the width value of the at least one feature map in the feature map set and the number of channels corresponding to the feature map set as variables, and obtain the channel dimension variance based on the channel dimension mean and the at least one feature map.

Optionally, when normalizing the feature map set based on the batch coordinate dimension to obtain a batch coordinate dimension variance and a batch coordinate dimension mean, the dimension normalization unit 42 is specifically configured to obtain the batch coordinate dimension mean based on the at least one feature map by using the height value and the width value of the at least one feature map in the feature map set and the amount of input data corresponding to the input data set as variables, and obtain the batch coordinate dimension variance based on the batch coordinate dimension mean and the at least one feature map.

In one or more optional embodiments, the dimension normalization unit 42 is configured to normalize the feature map set based on the spatial dimension to obtain a spatial dimension variance and a spatial dimension mean, obtain a channel dimension variance and a channel dimension mean corresponding to the channel dimension based on the spatial dimension variance and the spatial dimension mean, and obtain a batch coordinate dimension variance and a batch coordinate dimension mean corresponding to the batch coordinate dimension based on the spatial dimension variance and the spatial dimension mean.

The method of calculating the mean μₖ and the variance σₖ directly according to formula (1) brings about a large amount of redundant calculation; moreover, the three dimension statistics are dependent on one another. Therefore, in the embodiments, the statistics are calculated by means of the relationship among the dimensions by first calculating the spatial dimension variance and the spatial dimension mean and then calculating the means and variances on the channel dimension and the batch coordinate dimension based on the spatial dimension variance and the spatial dimension mean, thereby reducing the redundancy.

Optionally, when normalizing the feature map set based on the spatial dimension to obtain a spatial dimension variance and a spatial dimension mean, the dimension normalization unit 42 is configured to obtain the spatial dimension mean based on at least one feature map by using a height value and a width value of the at least one feature map in the feature map set as variables, and obtain the spatial dimension variance based on the spatial dimension mean and the at least one feature map.

Optionally, when obtaining a channel dimension variance and a channel dimension mean corresponding to the channel dimension based on the spatial dimension variance and the spatial dimension mean, the dimension normalization unit 42 is configured to obtain the channel dimension mean based on the spatial dimension mean by using the number of channels corresponding to the feature map set as a variable, and obtain the channel dimension variance based on the spatial dimension mean, the spatial dimension variance, and the channel dimension mean by using the number of channels corresponding to the feature map set as the variable.

Optionally, when obtaining a batch coordinate dimension variance and a batch coordinate dimension mean corresponding to the batch coordinate dimension based on the spatial dimension variance and the spatial dimension mean, the dimension normalization unit 42 is configured to obtain the batch coordinate dimension mean based on the spatial dimension mean by using the amount of input data corresponding to the input data set as a variable, and obtain the batch coordinate dimension variance based on the spatial dimension mean, the spatial dimension variance, and the batch coordinate dimension mean by using the amount of input data corresponding to the input data set as the variable.

In one or more optional embodiments, when determining a normalized target feature map set based on the at least one dimension variance and the at least one dimension mean, the batch normalization unit 43 is configured to weighted-average the at least one dimension variance to obtain a normalized variance and weighted-average the at least one dimension mean to obtain a normalized mean, and determine the target feature map set based on the normalized variance and the normalized mean.

In the embodiments, the feature map set is processed just by means of the normalized variance and the normalized mean to obtain the target feature map set. Optionally, a difference between at least one feature map in the feature map set and the normalized mean is calculated, and the difference is divided by the normalized variance to obtain a target feature map so as to obtain the target feature map set.

Optionally, when determining the target feature map set based on the normalized variance and the normalized mean, the batch normalization unit 43 is configured to process the feature map set based on the normalized variance, the normalized mean, a scaling parameter, and a translation parameter to obtain the target feature map set.

In the embodiments, a formula for batch normalization calculation in the prior art is adjusted to obtain an adaptive normalization formula, shown as formula (5), and the target feature map set is calculated based on formula (5).

In one or more optional embodiments, the apparatus may further include:

a result determination unit, configured to determine at least one data result corresponding to the input data set based on the target feature map set.

The normalization operation is based on the feature map output by means of the network layer; the feature map set obtained by the deep neural network is normalized and then continues to be processed to obtain the data result; for deep neural networks having different tasks, different data results (such as a classification result, a segmentation result, and an identification result) are output.

In one or more optional embodiments, the input data is sample data having annotation information; and

the apparatus according to the embodiments of the present disclosure further includes:

a training unit, configured to train the deep neural network based on a sample data set.

The sample data set includes at least one piece of sample data; normalization is performed from at least one dimension; parameters in the normalization layer of the deep neural network need to be trained to obtain a feature map with a better normalization effect; the addition of the normalization layer in the deep neural network for training can make the training converged more quickly and achieve the better training effect.

Optionally, the deep neural network includes at least one network layer and at least one normalization layer;

the input unit 41 is further configured to input the sample data set into the deep neural network, and output a sample feature map set by means of the network layer, the sample feature map set including at least one sample feature map;

the dimension normalization unit 42 is further configured to normalize, by means of the normalization layer, the sample feature map set from at least one dimension to obtain at least one sample dimension variance and at least one sample dimension mean;

the batch normalization unit 43 is further configured to determine a normalized prediction feature map set based on the at least one sample dimension variance and the at least one sample dimension mean;

the result determination unit is further configured to determine a prediction result corresponding to sample data based on the prediction feature map set; and

the training unit is configured to adjust parameters of the at least one network layer and parameters of the at least one normalization layer based on the prediction result and the annotation information.

Optionally, the parameters of the normalization layer may include, but is not limited to, at least one of: a weight value corresponding to the dimension, a scaling parameter, or a translation parameter.

Optionally, the weight value may include, but is not limited to, at least one of: a spatial dimension weight value, a channel dimension weight value, or a batch coordinate dimension weight value.

Optionally, the dimension normalization unit 42 is configured to normalize the sample feature map set based on the spatial dimension to obtain a sample spatial dimension variance and a sample spatial dimension mean; and/or,

normalize the sample feature map set based on the channel dimension to obtain a sample channel dimension variance and a sample channel dimension mean; and/or,

normalize the sample feature map set based on the batch coordinate dimension to obtain a sample batch coordinate dimension variance and a sample batch coordinate dimension mean.

Optionally, when normalizing the sample feature map set based on the spatial dimension to obtain a sample spatial dimension variance and a sample spatial dimension mean, the dimension normalization unit 42 is configured to obtain the sample spatial dimension mean based on at least one sample feature map by using a height value and a width value of the at least one sample feature map in the sample feature map set as variables, and obtain the sample spatial dimension variance based on the sample spatial dimension mean and the at least one sample feature map.

Optionally, when normalizing the sample feature map set based on the channel dimension to obtain a sample channel dimension variance and a sample channel dimension mean, the dimension normalization unit 42 is configured to obtain the sample channel dimension mean based on the at least one sample feature map by using the height value and the width value of the at least one sample feature map in the sample feature map set and the number of channels corresponding to the sample feature map set as variables, and obtain the sample channel dimension variance based on the sample channel dimension mean and the at least one sample feature map.

Optionally, when normalizing the sample feature map set based on the batch coordinate dimension to obtain a sample batch coordinate dimension variance and a sample batch coordinate dimension mean, the dimension normalization unit 42 is configured to obtain the sample batch coordinate dimension mean based on the at least one sample feature map by using the height value and the width value of the at least one sample feature map in the sample feature map set and the amount of sample data corresponding to the sample data set as variables, and obtain the sample batch coordinate dimension variance based on the sample batch coordinate dimension mean and the at least one sample feature map.

In one or more optional embodiments, the dimension normalization unit 42 is configured to normalize the sample feature map set based on the spatial dimension to obtain a sample spatial dimension variance and a sample spatial dimension mean, obtain a sample channel dimension variance and a sample channel dimension mean corresponding to the channel dimension based on the sample spatial dimension variance and the sample spatial dimension mean, and obtain a sample batch coordinate dimension variance and a sample batch coordinate dimension mean corresponding to the batch coordinate dimension based on the sample spatial dimension variance and the sample spatial dimension mean.

The method of calculating the mean μₖ and the variance σₖ directly according to formula (1) brings about a large amount of redundant calculation; moreover, the three dimension statistics are dependent on one another. Therefore, in the embodiments, the statistics are calculated by means of the relationship among the dimensions by first calculating the spatial dimension variance and the spatial dimension mean and then calculating the means and variances on the channel dimension and the batch coordinate dimension based on the spatial dimension variance and the spatial dimension mean, thereby reducing the redundancy.

Optionally, when normalizing the sample feature map set based on the spatial dimension to obtain a sample spatial dimension variance and a sample spatial dimension mean, the dimension normalization unit 42 is configured to obtain the sample spatial dimension mean based on at least one sample feature map by using a height value and a width value of the at least one sample feature map in the sample feature map set as variables, and obtain the sample spatial dimension variance based on the sample spatial dimension mean and the at least one sample feature map.

Optionally, when obtaining a sample channel dimension variance and a sample channel dimension mean corresponding to the channel dimension based on the sample spatial dimension variance and the sample spatial dimension mean, the dimension normalization unit 42 is configured to obtain the sample channel dimension mean based on the sample spatial dimension mean by using the number of channels corresponding to the sample feature map set as a variable, and obtain the sample channel dimension variance based on the sample spatial dimension mean, the sample spatial dimension variance, and the sample channel dimension mean by using the number of channels corresponding to the sample feature map set as the variable.

Optionally, when obtaining a sample batch coordinate dimension variance and a sample batch coordinate dimension mean corresponding to the batch coordinate dimension based on the sample spatial dimension variance and the sample spatial dimension mean, the dimension normalization unit 42 is configured to obtain the sample batch coordinate dimension mean based on the sample spatial dimension mean by using the amount of sample data corresponding to the sample data set as a variable, and obtain the sample batch coordinate dimension variance based on the sample spatial dimension mean, the sample spatial dimension variance, and the sample batch coordinate dimension mean by using the amount of sample data corresponding to the sample data set as the variable.

Optionally, the batch normalization unit 43 is configured to weighted-average the at least one sample dimension variance to obtain a sample normalized variance, and weighted-average the at least one sample dimension mean to obtain a sample normalized mean; and process the sample feature map set based on the sample normalized variance, the sample normalized mean, a scaling parameter, and a translation parameter to obtain the prediction feature map set.

Optionally, the at least one sample dimension variance includes: the sample spatial dimension variance, the sample channel dimension variance, and the sample batch coordinate dimension variance; and

when weighted-averaging the at least one sample dimension variance to obtain the sample normalized variance, the batch normalization unit 43 is configured to sum a product of the sample spatial dimension variance and the spatial dimension weight value, a product of the sample channel dimension variance and the channel dimension weight value, and a product of the sample batch coordinate dimension variance and the batch coordinate dimension weight value, and obtain the sample normalized variance based on the obtained sum.

Optionally, the at least one sample dimension mean includes: the sample spatial dimension mean, the sample channel dimension mean, and the sample batch coordinate dimension mean; and

when weighted-averaging the at least one sample dimension mean to obtain the sample normalized mean, the batch normalization unit 43 is configured to sum a product of the sample spatial dimension mean and the spatial dimension weight value, a product of the sample channel dimension mean and the channel dimension weight value, and a product of the sample batch coordinate dimension mean and the batch coordinate dimension weight value, and obtain the sample normalized mean based on the obtained sum.

According to another aspect of the embodiments of the present disclosure, provided is an electronic device, including a processor, where the processor includes the normalization apparatus for a deep neural network according to any one of the foregoing embodiments.

According to still another aspect of the embodiments of the present disclosure, provided is an electronic device, including: a memory configured to store executable instructions; and

a processor configured to communicate with the memory to execute the executable instructions so as to complete operations of the normalization method for a deep neural network according to any one of the foregoing embodiments.

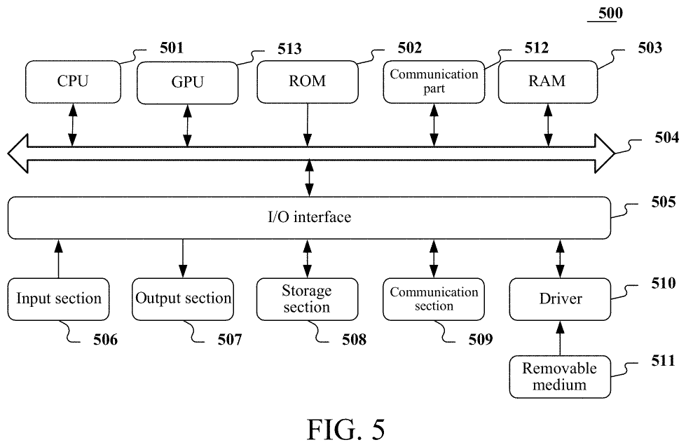

The embodiments of the present disclosure further provide an electronic device which, for example, is a mobile terminal, a Personal Computer (PC), a tablet computer, a server, and the like. Referring to FIG. 3 below, a schematic structural diagram of an electronic device 500, which is a terminal device or a server, suitable for implementing the embodiments of the present disclosure is shown. As shown in FIG. 5, the electronic device 500 includes one or more processors, a communication part, or the like. The one or more processors are, for example, one or more Central Processing Units (CPUs) 501 and/or one or more Graphic Processing Units (GPUs) 513, and may execute appropriate actions and processing according to executable instructions stored in a Read-Only Memory (ROM) 502 or executable instructions loaded from a storage section 508 to a Random Access Memory (RAM) 503. The communication part 512 may include, but is be limited to, a network card. The network card may include, but is not limited to, an Infiniband (IB) network card.

The processor is communicated with the ROM 502 and/or the RAM 503 to execute the executable instructions, and is connected to the communication part 512 by means of a bus 504 and communicated with other target devices by means of the communication part 512, so as to complete the operations corresponding to any of the methods provided in the embodiments of the present disclosure, for example, inputting an input data set into a deep neural network, normalizing a feature map set output by means of a network layer in the deep neural network from at least one dimension to obtain at least one dimension variance and at least one dimension mean, and determining a normalized target feature map set based on the at least one dimension variance and the at least one dimension mean.

In addition, the RAM 503 may further store various programs and data required for operations of an apparatus. The CPU 501, the ROM 502, and the RAM 503 are connected to each other via the bus 504. In the presence of the RAM 503, the ROM 502 is an optional module. The RAM 503 stores executable instructions, or writes the executable instructions into the ROM 502 during running, where the executable instructions cause the CPU 501 to execute corresponding operations of the foregoing communication method. An Input/Output (I/O) interface 505 is also connected to the bus 504. The communication part 512 is integrated, or is configured to have multiple sub-modules (for example, multiple IB network cards) connected to the bus.

The following components are connected to the I/O interface 505: an input section 506 including a keyboard, a mouse and the like; an output section 507 including a Cathode-Ray Tube (CRT), a Liquid Crystal Display (LCD), a speaker and the like; the storage section 508 including a hard disk drive and the like; and a communication section 509 of a network interface card including an LAN card, a modem and the like. The communication section 509 performs communication processing via a network such as the Internet. A drive 510 is also connected to the I/O interface 505 according to requirements. A removable medium 511 such as a magnetic disk, an optical disk, a magneto-optical disk, a semiconductor memory or the like is mounted on the drive 510 according to requirements, so that a computer program read from the removable medium is installed on the storage section 508 according to requirements.

It should be noted that the architecture illustrated in FIG. 5 is merely an optional implementation mode. During specific practice, the number and types of the components in FIG. 5 are selected, decreased, increased, or replaced according to actual requirements. Different functional components are separated or integrated or the like. For example, the GPU 513 and the CPU 501 are separated, or the GPU 513 is integrated on the CPU 501, and the communication part are separated from or integrated on the CPU 501 or the GPU 513 or the like. These alternative implementations all fall within the scope of protection of this disclosure.

Particularly, a process described above with reference to a flowchart according to the embodiments of the present disclosure is implemented as a computer software program. For example, the embodiments of the present disclosure include a computer program product, including a computer program tangibly included on a machine readable medium; the computer program includes program codes for executing the method shown in the flowchart; the program codes may include corresponding instructions for executing steps of the method provided in the embodiments of the present disclosure, for example, inputting an input data set into a deep neural network, normalizing a feature map set output by means of a network layer in the deep neural network from at least one dimension to obtain at least one dimension variance and at least one dimension mean, and determining a normalized target feature map set based on the at least one dimension variance and the at least one dimension mean. In such embodiments, the computer program is downloaded and installed from the network through the communication section 509, and/or is installed from the removable medium 511. The computer program, when being executed by the CPU 501, executes the operations of the foregoing functions defined in the method of the present disclosure.

According to yet another aspect of the embodiments of the present disclosure, provided is a computer readable storage medium configured to store computer readable instructions, where when the instructions are executed, operations of the normalization method for a deep neural network according to any one of the foregoing embodiments are implemented.

According to yet another aspect of the embodiments of the present disclosure, a computer program product is provided, including computer readable codes, where when the computer readable codes run in a device, a processor in the device executes instructions for implementing the normalization method for a deep neural network according to any one of the foregoing embodiments.

The methods and apparatuses of the present disclosure are implemented in many manners. For example, the methods and apparatuses of the present disclosure are implemented with software, hardware, firmware, or any combination of software, hardware, and firmware. Unless otherwise specially stated, the foregoing sequences of steps of the methods are merely for description, and are not intended to limit the steps of the methods of the present disclosure. In addition, in some embodiments, the present disclosure may also be implemented as programs recorded in a recording medium. The programs include machine-readable instructions for implementing the methods according to the present disclosure. Therefore, the present disclosure further covers the recording medium storing the programs for executing the methods according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual application of the present disclosure, and to make a person of ordinary skill in the art understand the present disclosure, so as to design various embodiments with various modifications applicable to particular use.

1. A normalization method for a deep neural network, comprising:
inputting an input data set into a deep neural network, the input data set comprising at least one piece of input data;
normalizing a feature map set output by means of a network layer in the deep neural network from at least one dimension to obtain at least one dimension variance and at least one dimension mean, the feature map set comprising at least one feature map, the feature map set corresponding to at least one channel, and each channel corresponding to at least one feature map; and
determining a normalized target feature map set based on the at least one dimension variance and the at least one dimension mean.

2. The method according to claim 1, wherein the dimension comprises at least one of:
a spatial dimension, a channel dimension, or a batch coordinate dimension, and
normalizing the feature map set output by means of the neural network layer from at least one dimension to obtain at least one dimension variance and at least one dimension mean comprises:
normalizing the feature map set based on the spatial dimension to obtain a spatial dimension variance and a spatial dimension mean; and/or, normalizing the feature map set based on the channel dimension to obtain a channel dimension variance and a channel dimension mean; and/or, normalizing the feature map set based on the batch coordinate dimension to obtain a batch coordinate dimension variance and a batch coordinate dimension mean; or
normalizing the feature map set based on the spatial dimension to obtain a spatial dimension variance and a spatial dimension mean; obtaining a channel dimension variance and a channel dimension mean corresponding to the channel dimension based on the spatial dimension variance and the spatial dimension mean; and obtaining a batch coordinate dimension variance and a batch coordinate dimension mean corresponding to the batch coordinate dimension based on the spatial dimension variance and the spatial dimension mean.

3. The method according to claim 2, wherein
normalizing the feature map set based on the channel dimension to obtain the channel dimension variance and the channel dimension mean comprises:
obtaining the channel dimension mean based on at least one feature map by using a height value and a width value of the at least one feature map in the feature map set and the number of channels corresponding to the feature map set as variables; and
obtaining the channel dimension variance based on the channel dimension mean and the at least one feature map, and/or
normalizing the feature map set based on the batch coordinate dimension to obtain the batch coordinate dimension variance and the batch coordinate dimension mean comprises:
obtaining the batch coordinate dimension mean based on the at least one feature map by using the height value and the width value of the at least one feature map in the feature map set and the amount of input data corresponding to the input data set as variables; and
obtaining the batch coordinate dimension variance based on the batch coordinate dimension mean and the at least one feature map, and/or
normalizing the feature map set based on the spatial dimension to obtain the spatial dimension variance and the spatial dimension mean comprises:
obtaining the spatial dimension mean based on the at least one feature map by using the height value and the width value of the at least one feature map in the feature map set as variables; and
obtaining the spatial dimension variance based on the spatial dimension mean and the at least one feature map, and/or
obtaining the channel dimension variance and the channel dimension mean corresponding to the channel dimension based on the spatial dimension variance and the spatial dimension mean comprises:
obtaining the channel dimension mean based on the spatial dimension mean by using the number of channels corresponding to the feature map set as a variable; and
obtaining the channel dimension variance based on the spatial dimension mean, the spatial dimension variance, and the channel dimension mean by using the number of channels corresponding to the feature map set as the variable, and/or
obtaining the batch coordinate dimension variance and the batch coordinate dimension mean corresponding to the batch coordinate dimension based on the spatial dimension variance and the spatial dimension mean comprises:
obtaining the batch coordinate dimension mean based on the spatial dimension mean by using the amount of input data corresponding to the input data set as a variable; and
obtaining the batch coordinate dimension variance based on the spatial dimension mean, the spatial dimension variance, and the batch coordinate dimension mean by using the amount of input data corresponding to the input data set as the variable.

4. The method according to claim 1, wherein determining the normalized target feature map set based on the at least one dimension variance and the at least one dimension mean comprises:
weighted-averaging the at least one dimension variance to obtain a normalized variance, and weighted-averaging the at least one dimension mean to obtain a normalized mean; and
determining the target feature map set based on the normalized variance and the normalized mean.

5. The method according to claim 4, wherein determining the target feature map set based on the normalized variance and the normalized mean comprises:
processing the feature map set based on the normalized variance, the normalized mean, a scaling parameter, and a translation parameter to obtain the target feature map set.

6. The method according to claim 1, further comprising:
determining at least one data result corresponding to the input data set based on the target feature map set.

7. The method according to claim 1, wherein the input data is sample data having annotation information; and
the method further comprises:
training the deep neural network based on a sample data set, the sample data set comprising at least one piece of sample data.

8. The method according to claim 7, wherein the deep neural network comprises at least one network layer and at least one normalization layer; and
training the deep neural network based on the sample data set comprises:
inputting the sample data set into the deep neural network, and outputting a sample feature map set by means of the network layer, the sample feature map set comprising at least one sample feature map;
normalizing, by means of the normalization layer, the sample feature map set from at least one dimension to obtain at least one sample dimension variance and at least one sample dimension mean;
determining a normalized prediction feature map set based on the at least one sample dimension variance and the at least one sample dimension mean;
determining a prediction result corresponding to the sample data based on the prediction feature map set; and
adjusting parameters of the at least one network layer and parameters of the at least one normalization layer based on the prediction result and the annotation information,
the parameters of the normalization layer comprise at least one of: a weight value corresponding to the dimension, a scaling parameter, or a translation parameter, and
the weight value comprises at least one of:
a spatial dimension weight value, a channel dimension weight value, or a batch coordinate dimension weight value.

9. The method according to claim 8, wherein normalizing, by means of the normalization layer, the sample feature map set from at least one dimension to obtain at least one sample dimension variance and at least one sample dimension mean comprises:
normalizing the sample feature map set based on the spatial dimension to obtain a sample spatial dimension variance and a sample spatial dimension mean; and/or, normalizing the sample feature map set based on the channel dimension to obtain a sample channel dimension variance and a sample channel dimension mean; and/or, normalizing the sample feature map set based on the batch coordinate dimension to obtain a sample batch coordinate dimension variance and a sample batch coordinate dimension mean, or
normalizing the sample feature map set based on the spatial dimension to obtain a sample spatial dimension variance and a sample spatial dimension mean; obtaining a sample channel dimension variance and a sample channel dimension mean corresponding to the channel dimension based on the sample spatial dimension variance and the sample spatial dimension mean; and obtaining a sample batch coordinate dimension variance and a sample batch coordinate dimension mean corresponding to the batch coordinate dimension based on the sample spatial dimension variance and the sample spatial dimension mean.

10. The method according to claim 9, wherein
normalizing the sample feature map set based on the channel dimension to obtain the sample channel dimension variance and the sample channel dimension mean comprises:
obtaining the sample channel dimension mean based on at least one sample feature map by using a height value and a width value of the at least one sample feature map in the sample feature map set and the number of channels corresponding to the sample feature map set as variables; and
obtaining the sample channel dimension variance based on the sample channel dimension mean and the at least one sample feature map, and/or
normalizing the sample feature map set based on the batch coordinate dimension to obtain the sample batch coordinate dimension variance and the sample batch coordinate dimension mean comprises:
obtaining the sample batch coordinate dimension mean based on the at least one sample feature map by using the height value and the width value of the at least one sample feature map in the sample feature map set and the amount of sample data corresponding to the sample data set as variables; and
obtaining the sample batch coordinate dimension variance based on the sample batch coordinate dimension mean and the at least one sample feature map, and/or
normalizing the sample feature map set based on the spatial dimension to obtain the sample spatial dimension variance and the sample spatial dimension mean comprises:
obtaining the sample spatial dimension mean based on at least one sample feature map by using the height value and the width value of the at least one sample feature map in the sample feature map set as variables; and
obtaining the sample spatial dimension variance based on the sample spatial dimension mean and the at least one sample feature map, and/or
obtaining the sample channel dimension variance and the sample channel dimension mean corresponding to the channel dimension based on the sample spatial dimension variance and the sample spatial dimension mean comprises:
obtaining the sample channel dimension mean based on the sample spatial dimension mean by using the number of channels corresponding to the sample feature map set as a variable; and
obtaining the sample channel dimension variance based on the sample spatial dimension mean, the sample spatial dimension variance, and the sample channel dimension mean by using the number of channels corresponding to the sample feature map set as the variable, and/or
obtaining the sample batch coordinate dimension variance and the sample batch coordinate dimension mean corresponding to the batch coordinate dimension based on the sample spatial dimension variance and the sample spatial dimension mean comprises:
obtaining the sample batch coordinate dimension mean based on the sample spatial dimension mean by using the amount of sample data corresponding to the sample data set as a variable; and
obtaining the sample batch coordinate dimension variance based on the sample spatial dimension mean, the sample spatial dimension variance, and the sample batch coordinate dimension mean by using the amount of sample data corresponding to the sample data set as the variable.

11. The method according to claim 8, wherein determining the normalized prediction feature map set based on the at least one sample dimension variance and the at least one sample dimension mean comprises:
weighted-averaging the at least one sample dimension variance to obtain a sample normalized variance, and weighted-averaging the at least one sample dimension mean to obtain a sample normalized mean; and
processing the sample feature map set based on the sample normalized variance, the sample normalized mean, a scaling parameter, and a translation parameter to obtain the prediction feature map set.

12. A normalization apparatus for a deep neural network, comprising:
a processor; and
a memory having stored thereon instructions that, when executed by the processor, cause the processor to:
input an input data set into a deep neural network, the input data set comprising at least one piece of input data;
normalize a feature map set output by means of a network layer in the deep neural network from at least one dimension to obtain at least one dimension variance and at least one dimension mean, the feature map set comprising at least one feature map, the feature map set corresponding to at least one channel, and each channel corresponding to at least one feature map; and
determine a normalized target feature map set based on the at least one dimension variance and the at least one dimension mean.

13. The apparatus according to claim 12, wherein the dimension comprises at least one of:
a spatial dimension, a channel dimension, or a batch coordinate dimension, and
normalizing the feature map set output by means of the neural network layer from at least one dimension to obtain at least one dimension variance and at least one dimension mean comprises:
normalizing the feature map set based on the spatial dimension to obtain a spatial dimension variance and a spatial dimension mean; and/or, normalizing the feature map set based on the channel dimension to obtain a channel dimension variance and a channel dimension mean; and/or, normalizing the feature map set based on the batch coordinate dimension to obtain a batch coordinate dimension variance and a batch coordinate dimension mean; or
normalizing the feature map set based on the spatial dimension to obtain a spatial dimension variance and a spatial dimension mean; obtaining a channel dimension variance and a channel dimension mean corresponding to the channel dimension based on the spatial dimension variance and the spatial dimension mean; and obtaining a batch coordinate dimension variance and a batch coordinate dimension mean corresponding to the batch coordinate dimension based on the spatial dimension variance and the spatial dimension mean.

14. The apparatus according to claim 13, wherein
normalizing the feature map set based on the channel dimension to obtain the channel dimension variance and the channel dimension mean comprises:
obtaining the channel dimension mean based on at least one feature map by using a height value and a width value of the at least one feature map in the feature map set and the number of channels corresponding to the feature map set as variables; and
obtaining the channel dimension variance based on the channel dimension mean and the at least one feature map, and/or
normalizing the feature map set based on the batch coordinate dimension to obtain the batch coordinate dimension variance and the batch coordinate dimension mean comprises:
obtaining the batch coordinate dimension mean based on the at least one feature map by using the height value and the width value of the at least one feature map in the feature map set and the amount of input data corresponding to the input data set as variables; and
obtaining the batch coordinate dimension variance based on the batch coordinate dimension mean and the at least one feature map, and/or
normalizing the feature map set based on the spatial dimension to obtain the spatial dimension variance and the spatial dimension mean comprises:
obtaining the spatial dimension mean based on the at least one feature map by using the height value and the width value of the at least one feature map in the feature map set as variables; and
obtaining the spatial dimension variance based on the spatial dimension mean and the at least one feature map, and/or
obtaining the channel dimension variance and the channel dimension mean corresponding to the channel dimension based on the spatial dimension variance and the spatial dimension mean comprises:
obtaining the channel dimension mean based on the spatial dimension mean by using the number of channels corresponding to the feature map set as a variable; and
obtaining the channel dimension variance based on the spatial dimension mean, the spatial dimension variance, and the channel dimension mean by using the number of channels corresponding to the feature map set as the variable, and/or
obtaining the batch coordinate dimension variance and the batch coordinate dimension mean corresponding to the batch coordinate dimension based on the spatial dimension variance and the spatial dimension mean comprises:
obtaining the batch coordinate dimension mean based on the spatial dimension mean by using the amount of input data corresponding to the input data set as a variable; and
obtaining the batch coordinate dimension variance based on the spatial dimension mean, the spatial dimension variance, and the batch coordinate dimension mean by using the amount of input data corresponding to the input data set as the variable.

15. The apparatus according to claim 12, wherein determining the normalized target feature map set based on the at least one dimension variance and the at least one dimension mean comprises:
weighted-averaging the at least one dimension variance to obtain a normalized variance, and weighted-averaging the at least one dimension mean to obtain a normalized mean; and
determining the target feature map set based on the normalized variance and the normalized mean.

16. The apparatus according to claim 15, wherein determining the target feature map set based on the normalized variance and the normalized mean comprises:
processing the feature map set based on the normalized variance, the normalized mean, a scaling parameter, and a translation parameter to obtain the target feature map set.

17. The apparatus according to claim 12, wherein the processor is further caused to:
determine at least one data result corresponding to the input data set based on the target feature map set.

18. The apparatus according to claim 12, wherein the input data is sample data having annotation information; and
the processor is further caused to:
train the deep neural network based on a sample data set, the sample data set comprising at least one piece of sample data.

19. The apparatus according to claim 18, wherein the deep neural network comprises at least one network layer and at least one normalization layer;
training the deep neural network based on the sample data set comprises:
inputting the sample data set into the deep neural network, and outputting a sample feature map set by means of the network layer, the sample feature map set comprising at least one sample feature map;
normalizing, by means of the normalization layer, the sample feature map set from at least one dimension to obtain at least one sample dimension variance and at least one sample dimension mean;
determining a normalized prediction feature map set based on the at least one sample dimension variance and the at least one sample dimension mean;
determining a prediction result corresponding to the sample data based on the prediction feature map set; and
adjusting parameters of the at least one network layer and parameters of the at least one normalization layer based on the prediction result and the annotation information,
the parameters of the normalization layer comprise at least one of: a weight value corresponding to the dimension, a scaling parameter, or a translation parameter, and
the weight value comprises at least one of:
a spatial dimension weight value, a channel dimension weight value, or a batch coordinate dimension weight value.

20. The apparatus according to claim 19, wherein normalizing, by means of the normalization layer, the sample feature map set from at least one dimension to obtain at least one sample dimension variance and at least one sample dimension mean comprises:
normalizing the sample feature map set based on the spatial dimension to obtain a sample spatial dimension variance and a sample spatial dimension mean; and/or, normalizing the sample feature map set based on the channel dimension to obtain a sample channel dimension variance and a sample channel dimension mean; and/or, normalizing the sample feature map set based on the batch coordinate dimension to obtain a sample batch coordinate dimension variance and a sample batch coordinate dimension mean, or
normalizing the sample feature map set based on the spatial dimension to obtain a sample spatial dimension variance and a sample spatial dimension mean; obtaining a sample channel dimension variance and a sample channel dimension mean corresponding to the channel dimension based on the sample spatial dimension variance and the sample spatial dimension mean; and obtaining a sample batch coordinate dimension variance and a sample batch coordinate dimension mean corresponding to the batch coordinate dimension based on the sample spatial dimension variance and the sample spatial dimension mean.

21. The apparatus according to claim 20, wherein
normalizing the sample feature map set based on the channel dimension to obtain the sample channel dimension variance and the sample channel dimension mean comprises:
obtaining the sample channel dimension mean based on at least one sample feature map by using a height value and a width value of the at least one sample feature map in the sample feature map set and the number of channels corresponding to the sample feature map set as variables; and
obtaining the sample channel dimension variance based on the sample channel dimension mean and the at least one sample feature map, and/or
normalizing the sample feature map set based on the batch coordinate dimension to obtain the sample batch coordinate dimension variance and the sample batch coordinate dimension mean comprises:
obtaining the sample batch coordinate dimension mean based on the at least one sample feature map by using the height value and the width value of the at least one sample feature map in the sample feature map set and the amount of sample data corresponding to the sample data set as variables; and
obtaining the sample batch coordinate dimension variance based on the sample batch coordinate dimension mean and the at least one sample feature map, and/or
normalizing the sample feature map set based on the spatial dimension to obtain the sample spatial dimension variance and the sample spatial dimension mean comprises:
obtaining the sample spatial dimension mean based on at least one sample feature map by using the height value and the width value of the at least one sample feature map in the sample feature map set as variables; and
obtaining the sample spatial dimension variance based on the sample spatial dimension mean and the at least one sample feature map, and/or
obtaining the sample channel dimension variance and the sample channel dimension mean corresponding to the channel dimension based on the sample spatial dimension variance and the sample spatial dimension mean comprises:
obtaining the sample channel dimension mean based on the sample spatial dimension mean by using the number of channels corresponding to the sample feature map set as a variable; and
obtaining the sample channel dimension variance based on the sample spatial dimension mean, the sample spatial dimension variance, and the sample channel dimension mean by using the number of channels corresponding to the sample feature map set as the variable, and/or
obtaining the sample batch coordinate dimension variance and the sample batch coordinate dimension mean corresponding to the batch coordinate dimension based on the sample spatial dimension variance and the sample spatial dimension mean comprises:
obtaining the sample batch coordinate dimension mean based on the sample spatial dimension mean by using the amount of sample data corresponding to the sample data set as a variable; and
obtaining the sample batch coordinate dimension variance based on the sample spatial dimension mean, the sample spatial dimension variance, and the sample batch coordinate dimension mean by using the amount of sample data corresponding to the sample data set as the variable.

22. The apparatus according to claim 19, wherein determining the normalized prediction feature map set based on the at least one sample dimension variance and the at least one sample dimension mean comprises:
weighted-averaging the at least one sample dimension variance to obtain a sample normalized variance, and weighted-averaging the at least one sample dimension mean to obtain a sample normalized mean; and
processing the sample feature map set based on the sample normalized variance, the sample normalized mean, a scaling parameter, and a translation parameter to obtain the prediction feature map set.

23. A computer readable storage medium, configured to store computer readable instructions, wherein when the instructions are executed, operations of the normalization method for a deep neural network according to claim 1 are implemented.
